(19) United States
(12) Patent Application Publication
(10) Pub. No.: US 2023/0004775 A1
(43) Pub. Date: Jan. 5, 2023

(54) METHOD FOR IMPLEMENTING A HARDWARE ACCELERATOR OF A NEURAL NETWORK

(71) Applicant: BULL SAS, LES CLAYES SOUS BOIS (FR)

(72) Inventors: Alban BOURGE, LES CLAYES SOUS BOIS (FR); Meven MOGNOL, LES CLAYES SOUS BOIS (FR); Emrick SINITAMBIRIVOUTIN, LES CLAYES SOUS BOIS (FR)

(73) Assignee: BULL SAS, LES CLAYES SOUS BOIS (FR)

(21) Appl. No.: 17/614,081

(22) PCT Filed: May 18, 2020
(86) PCT No.: PCT/FR2020/050822

§ 371 Date: Sep. 8, 2022

(30) Foreign Application Priority Data
May 28, 2019 (FR) 1905681

(51) Int. Cl. G06N 3/04; G06N 3/063

(52) U.S. Cl. CPC G06N 3/04; G06N 3/063

(57) ABSTRACT

The invention relates to a method for implementing a hardware accelerator for a neural network, comprising: a step of interpreting an algorithm of the neural network in binary format, converting the neural network algorithm in binary format into a graphical representation, selecting building blocks from a library of predetermined building blocks, creating an organization of the selected building blocks, configuring internal parameters of the building blocks of the organization so that the organization of the selected and configured building blocks corresponds to said graphical representation; a step of determining an initial set of weights for the neural network; a step of completely synthesizing the organization of the selected and configured building blocks on the one hand, in a preselected FPGA programmable logic circuit (41) in a hardware accelerator (42) for the neural network, and on the other hand in a software driver for this hardware accelerator (42), this hardware accelerator (42) being specifically dedicated to the neural network so as to represent the entire architecture of the neural network without needing access to a memory (44) external to the FPGA programmable logic circuit (41) when passing from one layer to another layer of the neural network, a step of loading (48) the initial set of weights for the neural network into the hardware accelerator (42).

### FIELD OF THE INVENTION

The invention relates to the field of methods for implementing a hardware accelerator for a neural network, as well as the field of circuit boards implementing a hardware accelerator for a neural network. A method for implementing a hardware accelerator for a neural network is a method for implementing a hardware accelerator for a neural network algorithm.

### TECHNOLOGICAL BACKGROUND OF THE INVENTION

The methods for implementing a hardware accelerator for a neural network make it possible to create and train specific neural networks on a reconfigurable hardware target (FPGA for “Field-Programmable Gate Array”) and then use them on datasets. Several technical difficulties can be highlighted, both from a hardware and software standpoint.

From the software standpoint, these can concern the need to binarize neural networks, the desire to reduce the loss of precision, the advantage of being able to automate the binarization of a neural network in a floating representation, the portability of the binary network trained on the reconfigurable hardware target FPGA, and the use of a series of complex tools.

From the hardware standpoint, these can concern the complex architecture of neural networks and especially convolutional neural networks, the difficulty of scaling generic components, the current proliferation of new types of neural networks (possibly to be tested), and the search for a performance level per unit of power (in watts) consumed which is quite high and which can become very high in the embedded domain.

In addition to all these difficult and sometimes partially contradictory requirements raised by the prior art, the invention is also interested in achieving, for these methods for implementing a hardware accelerator for a neural network, a simplification of its use for a non-expert user concerning the software aspect and a certain automation in the manner of using a series of tools which are quite complex to manipulate and require a relatively high level of expertise.

According to a first prior art, it is known to implement a hardware accelerator for a neural network in an FPGA programmable logic circuit (Field Programmable Gate Array).

However, the operation of this hardware accelerator has two disadvantages:
it is relatively slow,
and its ratio of performance (performance in computation or performance in other data processing) to energy consumed is quite insufficient.

Many large manufacturers of FPGA reconfigurable hardware targets have attempted to market deep learning acceleration solutions and then attempted to encompass as many different neural network algorithms as possible, in order to be able to address the greatest number of potential users. As a result, their hardware accelerator for neural networks has adopted an architecture which allows processing, in a similar manner, neural networks of completely different structures and sizes, ranging from simple to complex. This type of architecture is qualified as systolic; it uses computation elements linked together in the form of a matrix, these computation elements being fed with a direct access cache memory (DMA for “Direct Access Memory”) which chains the loading and recording of weights and activations from a memory external to the FPGA programmable logic circuit.

### OBJECTS OF THE INVENTION

The aim of the invention is to provide a method for implementing a hardware accelerator for a neural network which at least partially overcomes the above disadvantages.

Indeed, according to the analysis of the invention, this implementation of the prior art remains very, general, meaning that it maintains a matrix of calculation elements as an acceleration kernel which must regularly be reloaded, at each new layer of the neural network or at each new operation performed by the neural network, and even reprogrammed with parameters stored in a memory external to the FPGA programmable logic circuit, which in turn has two disadvantages:
It takes a long time to reload the acceleration kernel each time,
and this “general and universal” structure is more difficult to optimize in terms of the ratio of performance to energy consumed.

The invention also proposes an implementation of the hardware accelerator in an FPGA programmable logic circuit, but unlike the prior art, the invention proposes an implementation of the entire neural network (and therefore all the layers of this neural network) that is both complete and specifically dedicated to this neural network:
thus eliminating the continual use of external memory, thus significantly improving the operating speed of this hardware accelerator,
and also allowing better optimization of the ratio of performance to energy consumed, thus also improving the operating efficiency of this hardware accelerator,
but using predefined building blocks from a common library for the various implementations,
although these building blocks are easily usable thanks to the prior specific formatting of the neural network algorithm, this specific formatting corresponding to a graphical representation,
this being done in order to advantageously preserve the following features in the implementation method:
   relatively simple and easy to run,
   and accessible even to designers and implementers who are not seasoned specialists in the manufacture of hardware accelerators for neural networks.

Some embodiments of the invention make it possible to implement an automatic construction chain for a hardware accelerator for algorithms of complex binarized convolutional neural networks.

To this end, the invention provides a method for implementing a hardware accelerator for a neural network, comprising: a step of interpreting an algorithm of the neural network in binary format, converting the neural network algorithm in binary format into a graphical representation, selecting building blocks from a library of predetermined building blocks, creating an organization of the selected building blocks, configuring internal parameters of the building blocks of the organization, so that the organization of the selected and configured building blocks corresponds to said graphical representation; a step of determining an initial set of weights for the neural network; a step of completely synthesizing the organization of the selected and configured building blocks on the one hand in a preselected FPGA programmable logic circuit in a hardware accelerator for the neural network and on the other hand in a software driver for this hardware accelerator, this hardware accelerator being specifically dedicated to the neural network so as to represent the entire architecture of the neural network without needing access to a memory external to the FPGA programmable logic circuit when passing from one layer to another layer of the neural network; a step of loading the initial set of weights for the neural network into the hardware accelerator.

To this end, the invention also provides a circuit board comprising: an FPGA programmable logic circuit; a memory external to the FPGA programmable logic circuit; a hardware accelerator for a neural network: fully implemented in the FPGA programmable logic circuit, specifically dedicated to the neural network so as to be representative of the entire architecture of the neural network without requiring access to a memory external to the FPGA programmable logic circuit when passing from one layer to another layer of the neural network, comprising: an interface to the external memory, an interface to the exterior of the circuit board, an acceleration kernel successively comprising: an information reading block, an information serialization block with two output channels, one to send input data to the layers of the neural network, the other to configure weights at the layers of the neural network, the layers of the neural network, an information deserialization block, an information writing block.

Preferably, the information reading block comprises a buffer memory, and the information writing block comprises a buffer memory.

By, using these buffers, the pace of the acceleration kernel is not imposed on the rest of the system.

To this end, the invention also provides an embedded device comprising a circuit board according to the invention.

The fact that a device is embedded makes the gain in speed and performance particularly critical, for a given mass and a consumed energy both of which the user of the neural network seeks to reduce as much as possible while retaining efficiency, and while guaranteeing simplicity and ease of use of the implementation method, for the designer and the implementer of the neural network.

Preferably, the embedded device according to the invention is an embedded device for computer vision.

According to preferred embodiments, the invention comprises one or more of the following features which can be used separately or in partial combinations or in complete combinations, with one or more of the above objects of the invention.

Preferably, the method for implementing a hardware accelerator for a neural network comprises, before the interpretation step, a step of binarization of the neural network algorithm, including an operation of compressing a floating point format to a binary format.

This preliminary compression operation will make it possible to transform the neural network algorithm so that it is even easier to manipulate in the next steps of the implementation method according to the invention which thus can therefore also accept a wider range of neural network algorithms as input.

Preferably, the method for implementing a hardware accelerator for a neural network comprises, before the interpretation step, a step of selecting from a library of predetermined models of neural network algorithms already in binary format.

Thus, the speed of advancement of the implementation method according to the invention can be further significantly accelerated, which is particularly advantageous in the case of similar or repetitive tasks.

Preferably, the internal parameters comprise the size of the neural network input data.

The size of the input data is a very useful element for configuring the building blocks more efficiently, and this element is readily available, therefore is an element advantageously integrated in a preferential manner into the configuration of building blocks.

Other internal parameters may also comprise the number of logic subcomponents included in each block of random access memory (RAM) and/or the parallelism of the computation block, meaning the number of words processed per clock cycle.

A higher number of logic subcomponents included in each computation block can in particular facilitate the implementation of the logic synthesis, at the cost of an increase in its overall complexity and therefore its cost.

The higher the parallelism of the computation block, the greater the number of words processed per clock cycle. The computation block has a higher throughput, at the expense of a higher complexity and cost.

Preferably, the neural network is convolutional, and the internal parameters also comprise the sizes of the convolutions of the neural network.

This type of neural network is of particularly interest, but it is also a little more complex to implement.

Preferably, the neural network algorithm in binary format is in the ONNX format “Open Neural Network eXchange”).

This format is particularly attractive, making the implementation method more smooth overall.

Preferably, the organization of the selected and configured building blocks is described by a VHDL code representative of an acceleration kernel of the hardware accelerator.

This type of coding is particularly attractive, making the description of the architecture more complete overall.

Preferably, the synthesizing step and the loading step are carried out by communication between a host computer and an FPGA circuit board including the FPGA programmable logic circuit, this communication advantageously being carried out by means of the OpenCL standard through a PCI Express type of communication channel.

The use of direct and immediate communication, between a host computer and an FPGA circuit board including the FPGA programmable logic circuit, makes the implementation method easier to implement overall for both the designer and the implementer of the neural network.

This type of communication channel and standard are particularly attractive, making the implementation method more smooth overall.

Preferably, the neural network is a neural network applied to computer vision, preferably to embedded computer vision.

In this field of application of computer vision, especially when integrated into embedded devices (therefore not devices which would be fixed in a computer station on the ground), the simultaneous requirements of efficiency, speed, and low energy consumption lead to extensive optimizations which are not very compatible with a simplification of the method for implementing a hardware accelerator for the neural network, which the invention has nevertheless chosen to do, because this unusual compromise in fact works well.

Preferably, the application in computer vision is an application in a surveillance camera, or an application in an image classification system, or an application in a vision device embedded in a motor vehicle.

Other features and advantages of the invention will become apparent upon reading the following description of a preferred embodiment of the invention, given as an example and with reference to the accompanying drawings.

### BRIEF DESCRIPTION OF DRAWINGS

FIG. 1 schematically represents an example of a functional architecture enabling the implementation of the method for implementing a hardware accelerator for a neural network according to one embodiment of the invention.

FIG. 2 schematically represents an example of a software architecture enabling the implementation of the method for implementing a hardware accelerator for a neural network according to one embodiment of the invention.

FIG. 3 schematically represents an example of a circuit board implementing a hardware accelerator for a neural network according to one embodiment of the invention.

FIG. 4 schematically represents an example of a kernel of a circuit board implementing a hardware accelerator for a neural network according to one embodiment of the invention.

### DETAILED DESCRIPTION OF EMBODIMENTS OF THE INVENTION

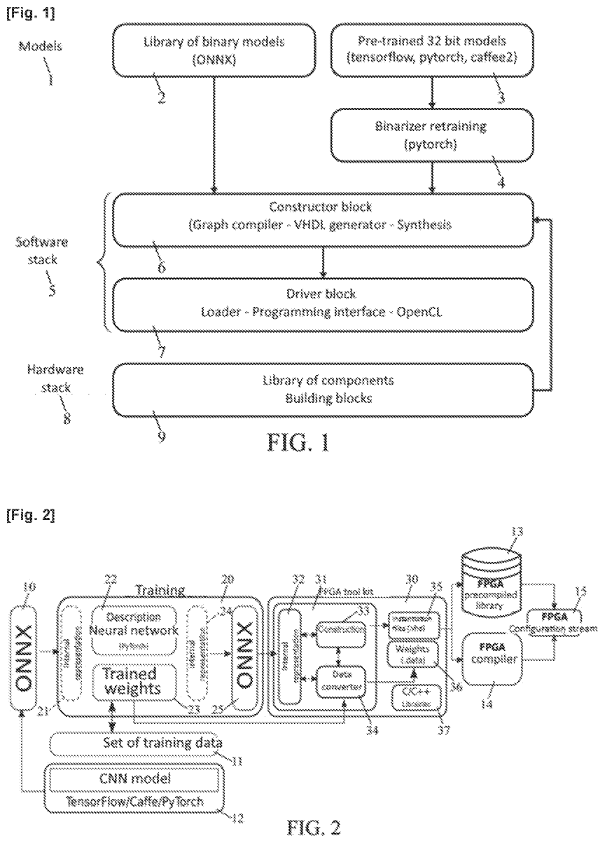

FIG. 1 schematically represents an example of a functional architecture enabling the implementation of the method for implementing a hardware accelerator for a neural network according to one embodiment of the invention.

The architecture has three layers: the models layer 1, the software stack layer 5, and the hardware stack layer 8.

The models layer 1 comprises a library 2 of binary models of neural network algorithms already in ONNX format, and a set 3 of models of neural network algorithms which are pre-trained but in a floating point format (32 bit), including in particular TENSORFLOW, PYTORCH, and CAFFEE2. The method for implementing a hardware accelerator for a neural network has two possible inputs: either a model already present in the library 2 or a model conventionally pre-trained in a non-fixed software architecture format (“framework”) belonging to the set 3. For a software architecture to be easily compatible with this implementation method, it is interesting to note that a converter of this software architecture to the ONNX format exists, ONNX being a transverse representation in all software architectures.

This set 3 of models of pre-trained neural network algorithms but in a floating point format can be binarized by a binarizer 4, possibly equipped with an additional function of re-training the neural network; for example, for PYTORCH, transforming the neural network algorithm models from a floating point format to a binary format, preferably to the binary ONNX format.

The hardware stack layer 8 comprises a library 9 of components, more precisely a library 9 of predetermined building blocks which will be selected and assembled together and each being parameterized, by the software stack layer 5 and more precisely by the constructor block 6 of the software stack layer 5.

The software stack layer 5 comprises, on the one hand, the constructor block 6 which will generate both the hardware accelerator for the neural network and the software driver for this hardware accelerator for the neural network, and on the other hand the driver block 7 which will use the driver software to drive the hardware accelerator for the neural network.

More precisely, the constructor block 6 comprises several functions, including: a graph compilation function which starts with a binarized neural network algorithm; a function for generating code in VHDL format (from “VHSIC Hardware Description Language”, VHSIC meaning “Very High Speed Integrated Circuit”), this code in VHDL format containing information both for implementing the hardware accelerator for the neural network and for the driver software of this hardware accelerator; and a synthesis function enabling actual implementation of the hardware accelerator for the neural network on an FPGA programmable logic circuit. The two inputs of the method for implementing the neural network accelerator come together in the constructor block step 6, which will study the neural network input algorithm and convert it into a clean graph representation. After this conversion of the graph, two products are therefore generated: the VHDL code describing the hardware accelerator including the acceleration kernel as well as the driver software of this hardware accelerator, which remains to be synthesized using synthesis tools, plus the corresponding neural network configuration weights.

More precisely, the driver block 7 comprises several functions including: a function of loading the VHDL code, a programming interface, and a function of communication between the host computer and the FPGA programmable logic circuit based on the technology of the OpenCL (“Open Computing Language”) software infrastructure. Once the hardware accelerator has been synthesized on the chosen target as an FPGA programmable logic circuit, for example using a suite of tools specific to the manufacturer of the FPGA programmable logic circuit, the driver block 7, which incorporates an application programming interface (API), for example in the Python programming language and the C++ programming language, is used to drive the hardware accelerator. Communication between the host computer and the FPGA is based on OpenCL technology, which is a standard.

Consequently, great freedom is offered to the user, who can create his or her own program after the generation of the acceleration kernel and the configuration. If the user wishes to target a particular FPGA programmable logic circuit not provided for by the method for implementing a hardware accelerator for a neural network according to the invention, it is still possible, in fact it is sufficient, that this type of model of an FPGA programmable logic circuit be supported by the suite of tools from the vendor of this FPGA programmable logic circuit.

One of the advantageous features of the method for implementing a hardware accelerator for a neural network proposed by the invention is to be compatible with complex neural network structures such as “ResNet” (for “Residential Network”) or “GoogLeNet”. These neural networks have the distinctive feature of divergent data paths, which are then merged or not merged according to various techniques (an “elt-wise” layer being the most common, for “element-wise”).

The graph compiler located in the constructor block 6 recognizes these features and translates them correctly into a corresponding hardware accelerator architecture.

FIG. 2 schematically represents an example of a software architecture enabling implementation of the method for implementing a hardware accelerator for a neural network according to one embodiment of the invention. A training block 20 corresponds to the re-training function of the binarizer 4 of FIG. 1, and a block 30 of an FPGA tool kit corresponds to the constructor block 6 of FIG. 1.

A model 12 of a convolutional neural network algorithm (CNN), for example in a TENSORFLOW, CARTE, or PYTORCH format, is transformed into a model 10 of a binarized convolutional neural network algorithm in ONNX format which is sent to an input of a training block 20. A set 11 of training data is sent to another input of this training block 20 to be transformed into trained weights 23 by interaction with a description 22 of the neural network. A conversion by internal representation 21 is made from the model 10 of the binarized convolutional neural network algorithm in ONNX format to the description 22 of the neural network which by interaction on the set 11 of training data gives the trained weights 23 which will be sent to an input of the block 30 of the FPGA toolkit. After this, the description 22 of the neural network is again converted by internal representation 24 to a binarized convolutional neural network algorithm 25 in ONNX format which in turn will be sent to another input of the FPGA toolkit block 30.

The binarized convolutional neural network algorithm 25 in ONNX format is converted by internal representation 32 and transformed by the cooperation of the construction function 33 and a data converter 34 having received the trained weights 23, in order to output an instantiation 35 of files (as “.vhd”) and a set of weights 36 (as “.data”), all using libraries 37 in the C and C++ programming languages. The data converter 34 puts the training weights in the proper format and associates them, in the form of a header, with guides, in order to reach the correct destinations in the correct layers of the neural network. The internal representation 32, the construction function 33, and the data converter 34 are grouped together in a sub-block 31.

At the output from the FPGA tool kit block 30, the pair formed by the instantiation 35 of the files and by the set of weights 36, can then either be compiled by an FPGA compiler 14, which can however take a considerable amount of time, or where appropriate can be associated with an already precompiled model in an FPGA precompiled library 13, which will be much faster but of course requires that this pair correspond to an already precompiled model which exists stored in the FPGA precompiled library 13. The obtained result, whether it comes from the FPGA precompiled library 13 or from the FPGA compiler 14, is an FPGA configuration stream 15.

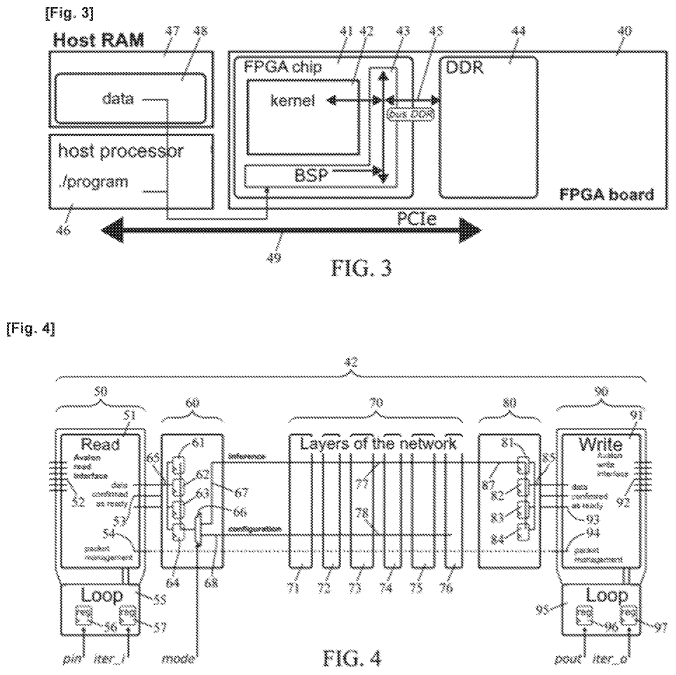

FIG. 3 schematically represents an example of a circuit board implementing a hardware accelerator for a neural network according to one embodiment of the invention.

A host computer integrating both a host processor 46 and a random access memory 47 (RAM), storing the data 48 required for the hardware accelerator for the neural network, communicates bidirectionally by means of a serial local bus 49, advantageously of the PCIe type (for “PO Express”, with PCI for “Peripheral Component Interconnect”), with the FPGA circuit board 40 implementing the hardware accelerator for the neural network, and in particular its acceleration kernel 42.

The FPGA circuit board 40 comprises an FPGA chip 41. This FPGA chip 41 houses the acceleration kernel 42 as well as a BSP interface 43 (for “Board Support Package”). The FPGA chip 41, and in particular the acceleration kernel 42, communicates with a memory 44 integrated onto the FPGA circuit board 40 via a DDR bus 45. The memory 44 is a memory internal to the FPGA circuit board 40, but external to the FPGA electronic chip 41; it has a high speed. This memory 44 is advantageously a memory of the DDR or DDR-2 type (in fact DDR SDRAM for “Double Data Rate Synchronous Dynamic Random Access Memory”).

When passing from one layer to another layer in the neural network, in the invention, neither the memory 47 external to the FPGA circuit board 40, nor the memory 44 internal to the FPGA circuit board 40 but external to the FPGA chip 41, are read from in order to load part of the hardware accelerator, unlike the prior art. Indeed, for the invention, the entire architecture of the neural network is loaded all at once at the start into the acceleration kernel 42 of the FPGA chip 41, while for the prior art, each layer is loaded separately after the use of the previous layer which it will then replace, requiring an exchange time and volume between the FPGA chip 41 and to the exterior of this FPGA chip 41 that are much greater than those of the invention for the same type of operation of the implemented neural network, therefore offering a much lower operating efficiency than that of the invention. It is because it is specifically dedicated to the neural network that the hardware accelerator can be loaded all at once; conversely, in the prior art, the hardware accelerator is general-purpose, and it must then be loaded layer by layer in order to “reprogram” it for each new layer, a loading all at once not being possible in the prior art without resorting to a very large size for the hardware accelerator. In the specific (and dedicated) hardware accelerator of the invention, the topology is multi-layered, which allows it, to be entirely implemented all at once without requiring too large of a size for the hardware accelerator, while in the prior art, the general-purpose hardware accelerator implements different topologies, one topology for each layer.

FIG. 3 thus represents the overall architecture of the system, comprising on the one hand the host machine including the host processor 46 and host memory 47, the user performing actions on said host machine, and on the other hand the hardware accelerator implemented on the FPGA circuit board 40. The host processor 46, which is general-purpose, controls and sends inputs/outputs, via a high-speed communication channel 49, to the accelerator FPGA circuit board 40 equipped with an FPGA chip 41 (FPGA programmable logic circuit), said FPGA chip 41 advantageously supporting the “OpenCL” standard.

FIG. 4 schematically represents an example of a kernel of a circuit board implementing a hardware accelerator for a neural network according to one embodiment of the invention.

The acceleration kernel 42 communicates with the BSP interface 43 (also based on the “OpenCL” communication standard), this communication being represented more specifically in FIG. 4, via an “Avalon” read interface 52 to a reading unit 50, in particular in order to receive from the host computer the input images and the configuration of the neural network, and via an “Avalon” write interface 92 to a writing block 90, in order to provide the obtained results that are output from the neural network. Furthermore, the acceleration kernel 42 receives the external parameters supplied by the user and more particularly from its call via the host processor, these external parameters arriving at the buffer memory 55 of the reading unit 50, the serialization unit 60, and the buffer memory 95 of the writing block 90.

The acceleration kernel 42 successively comprises, in series, firstly the reading unit 50, then the serialization block 60, then the layers 70 of the neural network itself, then the deserialization block 80, and finally the writing block 90. The signals reach the reading unit 50 via the read interface 52, and exit from their source writing block 90 via the write interface 92 by passing successively through the serialization block 60, layers 70 of the neural network, and the deserialization block 80. Packet management is ensured from start to end, from packet management 54 in the reading unit 50 to packet management 94 in the writing block 90, travelling successively (dotted lines) through the serialization block 60, the layers 70 of the neural network, and the deserialization block 80.

The reading unit 50 comprises a read interface 52 at its input, and comprises at its output a line 53 for sending input data (for the next serialization block 60) confirmed as ready for use. The reading unit 50 comprises a buffer memory 55 including registers 56 and 57 respectively receiving the external parameters “pin” and “iter_i”.

The serialization block 60 transforms the data 53 arriving from the reading unit 50 into data 65 stored in registers 61 to 64, for example in 512 registers although only 4 registers are represented in FIG. 4. These data stored in registers 61 to 64 will then be sent into the layers 70 of the neural network, either by the inference path 77 for the input data of the neural network, or by the configuration path 78 for the configuration weights of the neural network. A selector 68 selects either the inference path 77 or the configuration path 78, depending on the type of data to be sent to the layers 70 of the neural network.

The layers 70 of the neural network implement the multilayer topology of the neural network; here only 6 layers 71, 72, 73, 74, 75 and 76 are shown, but there may be more, or even significantly more, and also slightly fewer. Preferably, the neural network comprises at least 2 layers, more preferably at least 3 layers, even more preferably at least 5 layers, advantageously at least 10 layers. It is preferably a convolutional neural network.

The deserialization block 80 stores in registers 81 to 84 the data 87 arriving by the inference path 77, for example in 512 registers although only 4 registers are represented in FIG. 4. These data stored in registers 81 to 84 will then be sent to the writing block 90, more specifically from the output 85 of the deserialization block 80 to then be transmitted to the input 93 of the writing block 90. These data 87 are the data output from the neural network, the data resulting from the successive passage through layers 71 to 76 of neurons, meaning that they correspond to the desired result obtained after processing by the neural network.

The writing block 90 at its output comprises a write interface 92, and at its input comprises a line 93 for receiving the output data (from the previous deserialization block 80) confirmed ready to be transmitted to outside the acceleration kernel 42. The writing block 90 comprises a buffer memory 95 including registers 96 and 97 respectively receiving the external parameters “pout” and “iter_o”.

An example of a possible use of the method for implementing a hardware accelerator for a neural network according to the invention is now presented. A user will offload the inference of a “ResNet-50” type of network from a general-purpose microprocessor of the central processing unit type (CPU) to a more suitable hardware target, particularly from an energy performance standpoint. This user selects a target FPGA programmable logic circuit. He or she can use a pre-trained model of a neural network algorithm in a format such as “PyTorch”, which can be found on the Internet. This model of a neural network algorithm contains the configuration weights in a floating point representation of the neural network trained on a particular data set (“CIFAR-10” for example). The user can then select this model of a neural network algorithm in order to use the method for implementing a hardware accelerator for a neural network according to the invention. The user will then obtain an FPGA project as output, which the user will then synthesize before passing it on to a circuit board, as well as a binarized configuration compatible with the binary representation of the hardware accelerator for the neural network. This step will require the installation of proprietary tools corresponding to the target FPGA programmable logic circuit.

Next, the user runs the scripts of the constructor block 6 automatically generating the configuration of the target FPGA programmable logic circuit, in order to provide the hardware accelerator. When the user has this output, he or she uses the driver block 7 to load the description of the accelerator (“ResNet-50” network) into the target FPGA programmable logic circuit, provide the configuration of the pre-trained then binarized weights to the hardware accelerator, provide a set of input images, and retrieve the results of the neural network algorithm as output from the hardware accelerator.

It is possible to dispense with the relatively time-consuming portion of generating the hardware architecture from the “PyTorch” representation, provided that models are used from the library of precompiled networks. If the user chooses a hardware accelerator whose topology has already been generated (by the user or provided by the library of precompiled neural network algorithms), he or she only has to go through the step of model weight binarization, which is very fast, for example about a second.

Of course, the invention is not limited to the examples and to the embodiment described and shown, but is capable of numerous variants accessible to those skilled in the art.

1. A method for implementing a hardware accelerator for a neural network, comprising:
interpreting an algorithm of the neural network algorithm in binary format;
converting the neural network algorithm in binary format (25) into a graphical representation by:
selecting building blocks from a library (37) of predetermined building blocks;
creating (33) an organization of the selected building blocks; and
configuring internal parameters of the building blocks of the organization;
where the organization of the selected and configured building blocks corresponds to said graphical representation,
determining an initial set (36) of weights for the neural network,
completely synthesizing (13, 14) the organization of the selected and configured building blocks on the one hand in a preselected FPGA programmable logic circuit (41) in a hardware accelerator (42) for the neural network and on the other hand in a software driver for the hardware accelerator (42), the hardware accelerator (42) being specifically dedicated to the neural network so as to represent an entire architecture of the neural network without needing access to a memory (44) external to the FPGA programmable logic circuit (41) when passing from one layer (71 to 75) to another layer (72 to 76) of the neural network; and
loading (48) the initial set of weights for the neural network into the hardware accelerator (42).

2. The method for implementing a hardware accelerator for a neural network according to claim 1, further comprising, before the interpretation step (6, 30)), binarizing (4, 20) of the neural network algorithm, including an operation of compressing a floating point format to a binary format.

3. The method for implementing a hardware accelerator for a neural network according to claim 1, further comprising, before the interpretation step (6, 30), selecting from a library (8, 37) of predetermined models of neural network algorithms already in binary format.

4. The method for implementing a hardware accelerator for a neural network according to claim 1, wherein the internal parameters comprise a size of the neural network input data.

5. The method for implementing a hardware accelerator for a neural network according to claim 1, wherein the neural network is convolutional, and the internal parameters also comprise sizes of the convolutions of the neural network.

6. The method for implementing a hardware accelerator for a neural network according to claim 1, wherein the neural network algorithm in binary format (25) is in an ONNX format.

7. The method for implementing a hardware accelerator for a neural network according to claim 1, wherein the organization of the selected and configured building blocks is described by a VHDL code (15) representative of an acceleration kernel of the hardware accelerator (42).

8. The method for implementing a hardware accelerator for a neural network according to claim 1, wherein the synthesizing step (13, 14) and the loading step (48) are carried out by communication between a host computer (46, 47) and an FPGA circuit board (40) including the FPGA programmable logic circuit (41), this communication advantageously being carried out by means of an OpenCL standard through a PCI Express type of communication channel (49).

9. The method for implementing a hardware accelerator for a neural network according to claim 1, wherein the neural network is a neural network configured for an application in computer vision.

10. The method for implementing a hardware accelerator for a neural network according to claim 9, wherein the application in computer vision is an application in a surveillance camera, or an application in an image classification system, or an application in a vision device embedded in a motor vehicle.

11. A circuit board (40) comprising:
an FPGA programmable logic circuit (41);
a memory external to the FPGA programmable logic circuit (44); and
a hardware accelerator for a neural network that is fully implemented in the FPGA programmable logic circuit (41), and specifically dedicated to the neural network so as to be representative of an entire architecture of the neural network without requiring access to a memory (44) external to the FPGA programmable logic circuit when passing from one layer (71 to 75) to another layer (72 to 76) of the neural network, the hardware accelerator comprising:
an interface (45) to the external memory;
an interface (49) to an exterior of the circuit board; and
an acceleration kernel (42) successively comprising:
an information reading block (50);
an information serialization block (60) with two output channels (77, 78) including a first output channel (77) to send input data to the layers (70-76) of the neural network, and a second output channel (78) to configure weights at the layers (70-76) of the neural network;
the layers (70-76) of the neural network;
an information deserialization block (80); and
an information writing block (90).

12. The circuit board according to claim 11, wherein the information reading block (50) comprises a buffer memory (55), and the information writing block (90) comprises a buffer memory (95).

13. An embedded device, comprising a circuit board according to claim 11.

14. The embedded device according to claim 13, wherein the embedded device is an embedded device for computer vision.
